(19) United States
(12) Patent Application Publication
(10) Pub. No.: US 2010/0044999 A1
(43) Pub. Date: Feb. 25, 2010

(54) HITCH-MOUNTED LAWN AND GARDEN TRACTOR/ATV ACCESSORY SYSTEM

(76) Inventor: John R. Columbia, Brownsville, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 12/295,787

(22) PCT Filed: Apr. 3, 2007
(86) PCT No.: PCT/US07/65840

§ 371 Date: Oct. 5, 2009

Related U.S. Application Data
(63) Continuation of application No. 11/732,117, filed on Apr. 2, 2007.
(60) Provisional application No. 60/789,052, filed on Apr. 3, 2006.
(60) Provisional application No. 60/792,555, filed on Apr. 17, 2006.
(60) Provisional application No. 60/798,566, filed on May 8, 2006.
(60) Provisional application No. 60/789,052, filed on Apr. 3, 2006.
(60) Provisional application No. 60/792,555, filed on Apr. 17, 2006.
(60) Provisional application No. 60/798,566, filed on May 8, 2006.

(51) Int. Cl. B60D 1/06

(52) U.S. Cl. 280/511

(57) ABSTRACT

The hitch-mounted Lawn and Garden Tractor/ATV Accessory System provides an assembly for the attachment of one or more accessories, attachments, or implements to a lawn and garden tractor and/or ATV. The hitch-mounted support base of the accessory system accommodates the attachment of numerous accessories. With no restrictions to equipment brands and models, the accessory system is easily transferable from one equipment brand to the next as well as between lawn and garden tractors and ATVs, resulting in maximum versatility in accessory choice and use.

### CROSS REFERENCE TO RELATED PATENT APPLICATIONS

This application claims the benefits of U.S. Provisional Application No. 60/789,052, filed Apr. 3, 2006 and U.S. Provisional Application No. 60/792,555 filed Apr. 17, 2006, and is related to U.S. application Ser. No. 11/372,748, filed Mar. 10, 2006, all of which applications are herein incorporated by reference in their entirety.

### BACKGROUND OF THE INVENTION

1. Field of the Invention

The present invention relates generally to trailer hitch accessories, and more particularly to hitch-mounted accessories primarily for use on lawn and garden tractors and all-terrain vehicles (ATVs).

2. Technical Considerations

In recent years, the number and variety of lawn and garden tractor and ATV accessories and attachments that are secured to, or towed by, a lawn and garden tractor and/or ATV have increased significantly. However, in the current art, most of the lawn and garden tractor accessories are designed to be attached to the tractor's frame or fenders, and most of the ATV accessories continue to be designed to be attached to the ATV's rack system.

Although lawn and garden tractor accessory attachment via the frame or fenders and ATV accessory attachment via the rack can be effective, with few exceptions, the accessories are generally not quickly attached or detached. They are generally bolted to the lawn and garden tractor's frame or fenders and ATV's rack system and require the use of tools for installation and removal. In addition, in most cases, the accessories are only compatible and useable on the specific brand and/or model for which they were designed. Consequently, if a consumer replaces his or her equipment with a new model or different brand, by necessity, they would need to repurchase all new accessories. Additionally, in few cases, if any, are ATV accessories transferable for use on a lawn and garden tractor, nor are lawn and garden tractor accessories transferable for use on an ATV. In the known art, it was impractical to utilize an ATV's hitch receiver or drawbar for attaching accessories since historically it would have precluded the vehicle from being used for towing when the other accessory was attached to the ATV's receiver or drawbar. However, with the introduction of the multi-task trailer hitch assembly disclosed in copending U.S. application Ser. No. 11/372,748 entitled, “Multi-Task Trailer Hitch Assembly,” a vehicle's tow hitch can now be utilized for multiple purposes without sacrificing the ability to tow. In addition, while lawn and garden tractors are useful in performing outdoor chores, they are not adequately equipped with a mechanism for transporting hand tools or other items. In the present art, when transporting hand tools, the tractor operator generally carries or supports the tool with one hand while operating the tractor with his or her other hand.

Thus, a hitch-mounted lawn and garden tractor/ATV accessory system solving at least some of the aforementioned problems is desirable.

### SUMMARY OF THE INVENTION

A hitch-mounted lawn and garden tractor and/or ATV accessory system of the present invention provides a receiver-type hitch and accessory support base for the attachment of one or more accessories to a lawn and garden tractor and/or ATV. This permits the simultaneous use of multiple accessories that are easily attachable and detachable. The inventive hitch-mounted lawn and garden tractor/ATV accessory system is easily transferable from lawn and garden tractor to ATV, and vise-versa, regardless of equipment make or model.

The present invention provides a hitch-mounted accessory support base with multiple accessory connection tubes positioned at any desired orientation, for example both horizontally and vertically, and which can be oriented not only toward the rear but also at angles, e.g., right angles, from the support base. This permits fastening one or more attachments from not only the rear but also from the top and/or bottom, as well as inward from one or both sides toward the support base. In addition, accessories can be attached to the support base with any conventional type of connection, for example but not limited to tube connections, slide-over connections, slide-in connections, pinned connections, nut and bolt connections, and/or any other appropriate type connection.

In one embodiment of the present invention, the shank of the Hitch-Mounted Lawn and Garden Tractor/ATV Accessory System support base is directly mounted into an ATV's existing receiver tube. In another embodiment, the accessory system includes the accessory support base and receiver hitch for mounting on a lawn and garden tractor. In another embodiment, the support base is attached to an ATV or lawn and garden tractor with the Dual-Receiver Tube Assembly embodied in copending U.S. application Ser. No. 11/372,748 as described in Paragraph 0067 and depicted in FIG. 3D as Reference Character No. 24 of that application. In another embodiment, the support base fits over the exposed shank of a ball mount between the ball mount platform and the hitch receiver when the ball mount shank is engaged by the hitch receiver of a lawn and garden tractor or ATV. In another embodiment, the accessory support base fits over or on a receiver/ball extension when the use of a receiver/ball mount extension between the receiver and ball mount is desirable. In yet another embodiment, as a product improvement, the accessory support base of the present invention fits over or on a hitch accessory other than a ball mount or extension when the use of a different accessory is desirable.

In one specific embodiment, a hitch-mounted vehicle accessory system comprises an attachment shank configured to engage a vehicle hitch receiver, at least one support base member connected to the attachment shank, and at least one support element connected to the base member. The system can further comprise a plurality of accessory mounting tubes carried on the support element. The attachment shank can include a first end configured to engage a vehicle hitch receiver and a second end configured to receive a ball mount assembly or vehicle accessory assembly. The vehicle hitch receiver and attachment shank can each include at least one vertical throughbore. The accessory mounting tubes can include one or more of rearwardly opening tubes, upwardly opening tubes, or downwardly opening tubes. The support element can comprise a cross bar tube. The cross bar tube can comprise at least one rectangular receiver bore. The hitch receiver can be removably mounted on the vehicle. The hitch receiver can be attached to a mounting plate. The hitch receiver can include a drawbar bolt housing tube connected to the receiver tube. The drawbar bolt housing tube can include a split open channel and a drawbar attachment bolt slideable in the drawbar bolt housing tube and configured to engage a vehicle drawbar hole. A drawbar attachment bolt can be connected to the receiver tube.

Another hitch-mounted vehicle accessory system comprises a shank collar configured to engage a shank of a hitch accessory, a support base member connected to the shank collar, and at least one support element connected to the support base member. The shank collar can be removably connected to the shank of the hitch accessory. The hitch accessory can be, for example, a receiver adaptor or a ball mount assembly. The system can further comprise a plurality of support base members, such as two or more spaced base support tubes. An accessory support frame can be connected to the support base member.

It is an aspect of the invention to provide improved elements and arrangements thereof for the purposes described which is inexpensive, dependable, and fully effective in accomplishing its intended purposes.

These and other aspects of the present invention will become readily apparent upon further review of the following specification and drawings.

### BRIEF DESCRIPTION OF THE DRAWINGS

FIG. 1 is a perspective view of a hitch-mounted lawn and garden tractor/ATV accessory system of the invention utilizing an ATV's existing hitch receiver;

FIG. 2 is a side elevational view of the hitch-mounted lawn and garden tractor/ATV accessory system of FIG. 1;

FIG. 3 is a rear perspective view of another embodiment of the invention of FIG. 1 modified to include a receiver-type hitch for bolting to a lawn and garden tractor;

FIG. 4 is a side elevational view of the lawn and garden tractor hitch receiver of FIG. 3;

FIG. 5 is a bottom view of the lawn and garden tractor hitch receiver of FIG. 3;

FIG. 6 is a rear elevational view of the lawn and garden tractor hitch receiver of FIG. 3;

FIG. 7 is a rear perspective view of another embodiment of the invention of FIG. 1 modified to attach to a lawn and garden tractor/ATV via a shank collar;

FIG. 8 is a perspective view of yet another embodiment of the invention of FIG. 1 as mounted on a receiver/ball mount extension/reducer/adapter;

FIG. 9 is a perspective view of yet another embodiment of the invention of FIG. 1 as mounted on a hitch accessory other than a ball mount or ball mount extension;

FIG. 10 is a rear perspective view of yet another embodiment of the invention of FIG. 1 as mounted to an ATV or lawn and garden tractor with the Dual Receiver Tube Assembly embodying U.S. application Ser. No. 11/372,748 as described in Paragraph 0067 and shown in FIG. 3D as Reference Character 24 of that application; and

FIG. 11 is a perspective view of yet another embodiment of the invention of FIG. 1 modified to include an alternate receiver-type hitch from that shown in FIG. 3 for bolting to a lawn and garden tractor or ATV.

Similar reference characters denote corresponding features consistently throughout the attached drawings.

### DETAILED DESCRIPTION OF THE PREFERRED EMBODIMENTS

As used herein, spatial or directional terms, such as “top,” “bottom,” “left,” “right,” “over,” “under,” “front,” “rear,” and the like, relate to the invention as it is shown in the drawing figures. However, it is to be understood that the invention can assume various alternative orientations, and, accordingly, such terms are not to be considered as limiting. Further, all numbers expressing dimensions, physical characteristics, and so forth, used in the specification, figures, and claims are to be understood as being modified in all instances by the term “about.” Accordingly, unless indicated to the contrary, the numerical values set forth in the following specification, figures, and claims can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. The dimensions set forth on the accompanying drawing figures are for one exemplary embodiment of the invention and it is to be understood that the invention is not limited to the specifically disclosed dimensions.

An easy on/off hitch-mounted lawn and garden tractor/ATV accessory system of the present invention can attach and detach from the tow vehicle with a single standard hitch pin and the support base can accommodate the attachment of one or more practical and useful accessories. Accessories can be quickly and easily attached to, and detached from, the support base with one or two pins such as detent ring pins.

The accessories described and attached to the accessory system support base and illustrated in the drawings are intended to be illustrative and not exhaustive.

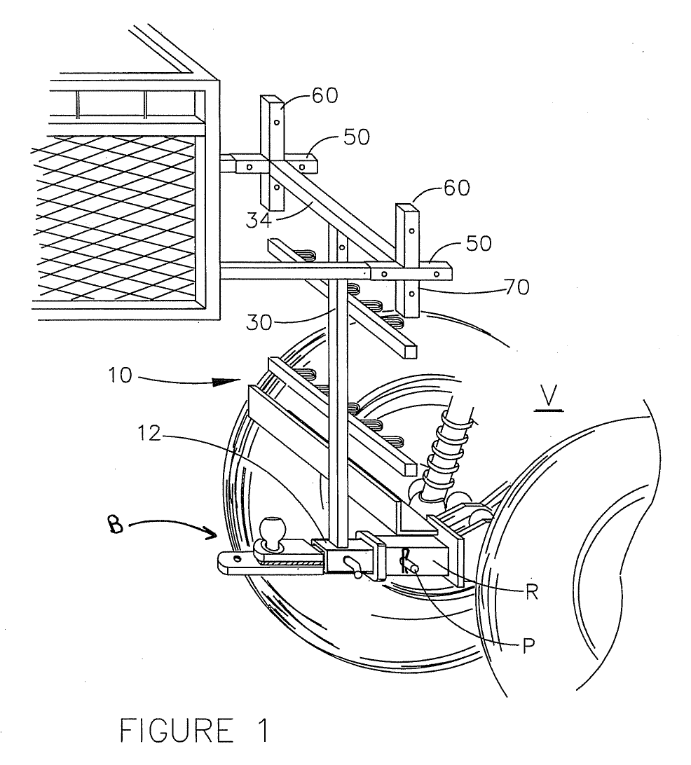

Referring to FIG. 1, there is shown an environmental perspective view of a first embodiment of the inventive hitch-mounted lawn and garden tractor/ATV accessory system referred to by the reference number 10. Accessory system 10 is shown mounted to a vehicle's existing hitch receiver R (shown as an ATV) by accessory system hitch attachment shank 12 and secured to the vehicle's receiver with hitch pin P. Hitch receiver R is mounted on vehicle V.

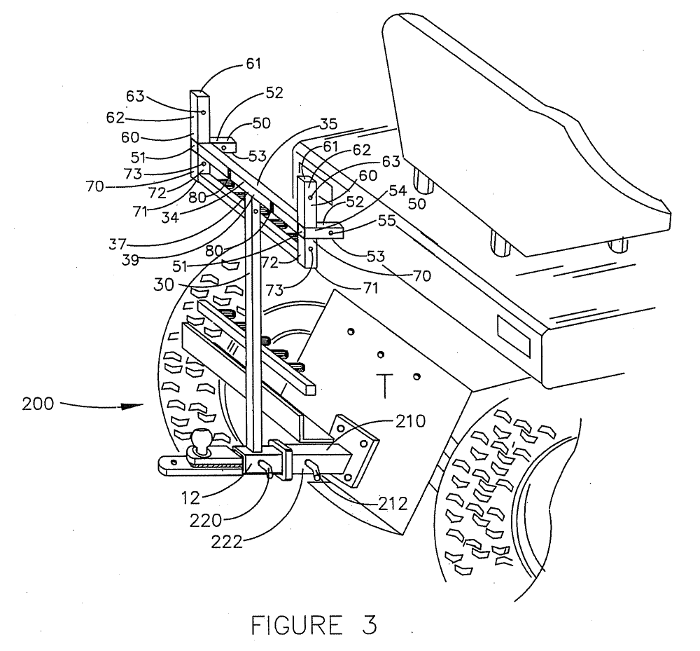

Accessory system's hitch attachment shank 12 serves as the accessory system's mounting shank for attaching to the vehicle by being inserted into the vehicle's hitch receiver R. Hitch attachment shank 12 also serves as a receiver tube for inserting a ball mount assembly B, as shown, to the accessory system for towing or for attaching other hitch receiver mounted accessories or implements. Accessory system's hitch attachment shank 12 has an upright tube support base member 30 extending upwardly therefrom. Cross member support element or tube 34 is mounted to support base member tube 30 and supports one or more dual accessory mounting tubes 50, 60, and 70 which are used for attaching various types of accessories to the system, such as a basket and tree stand carrier as shown. Cross member support 34 may also contain rectangular bores 80, as best seen in FIG. 3, for housing attachments containing rectangular-shaped support legs. Upright support base member tube 30 may also be used to secure a variety of accessories such as a tool caddy, as illustrated.

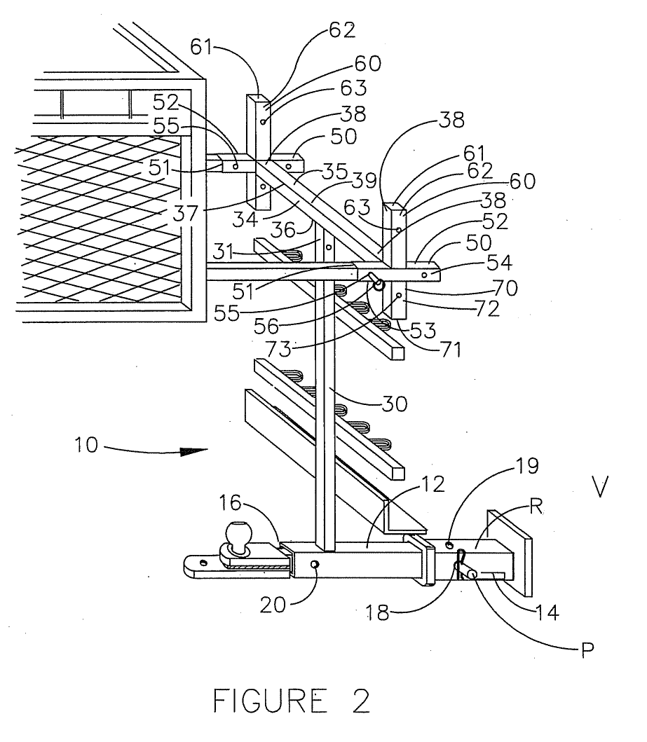

Referring to FIG. 2, there is shown a side elevational view of the embodiment of FIG. 1, wherein accessory system 10 has a hitch attachment shank 12, an upright tube support base member 30, cross member support tube 34, and dual accessory mounting tubes 50, 60 and 70.

In one non-limiting embodiment, the accessory system's hitch attachment shank 12 is square and hollow in cross section and has a forward end portion 14 and rearward end portion 16. The forward end portion 14 serves as the accessory system's mounting shank for inserting into the vehicle's hitch receiver R which has a conventional horizontal hitch pin throughbore 18 for securing accessory system 10 to vehicle V with hitch pin P. The rearward end portion 16 serves as a receiver tube for housing a ball mount assembly B or other hitch receiver mounted accessory and has a hitch pin bore 20 for pinning the ball mount assembly B or other accessories to accessory system's hitch attachment shank 12.

As can easily be recognized and appreciated by one skilled in the art, hitch assemblies, attachments and accessories for ATVs and lawn and garden tractors need not be of the same strength and/or rating as those designed for automotive use. Hitch assemblies and attachments for these off-road tow vehicles may be designed from less-expensive, lighter-duty materials and still function properly and serve their intended purpose. To facilitate the use of lighter-duty materials on off-road vehicles, such as ATVs and lawn and garden tractors, without risking the use of lighter-duty hitch assemblies and/or accessories on automotive type vehicles, the receiver-type hitch R of the present invention may include, as shown in FIG. 2, vertical hitch pin throughbore 19, in addition to conventional horizontal hitch pin throughbore 18. With inventive corresponding vertical throughbore in the attachment shank of a ball mount assembly, the attachment shank of the accessory system, or the attachment shank of any other accessory to be inserted into inventive receiver-type hitch R, can be fastened or pinned to inventive receiver R via vertical hitch pin throughbore 19. By not including a conventional horizontal hitch pin throughbore in the inventive shank of an accessory to be used in conjunction with inventive hitch receiver R, the lighter-duty accessory could only be secured to inventive hitch receiver R via inventive vertical hitch pin throughbore 19, for example with the use of a standard-type hitch pin P. By not including a conventional horizontal hitch pin throughbore in the inventive shank of a light-duty accessory, the accessory could not be fastened or pinned to a standard automotive hitch receiver via throughbore 18, but could be fastened to inventive receiver R via vertical hitch pin throughbore 19. In an alternative embodiment, since inventive hitch receiver R has inventive vertical hitch pin throughbore 19 as well as conventional horizontal hitch pin throughbore 18, conventional automotive-type hitch accessory shanks are compatible for use with inventive hitch receiver R since they can be fastened to inventive hitch receiver R via conventional horizontal hitch pin throughbore 18. Inventive hitch receiver R may be applied to all of the embodiments of the hitch-mounted lawn and garden tractor/ATV accessory system of the present invention described herein.

Accessory system's hitch attachment shank 12 has an upright tube support base member 30 extending upwardly therefrom. Cross member support tube 34 is mounted at the upper end 31 of upright support base member tube 30 and is shown as supporting dual accessory mounting tubes 50, 60, and 70. Upright support base member tube 30 can be used to attach a variety of accessories such as a tool caddy as illustrated. Accessories can be removably attached to support base member tube 30 with detent pins, or permanently affixed to the support tube as by welding. Cross bar tube 34 can be square in cross section and can have an upper wall 35, a lower wall 36, and side walls 37 and has end portions 38 at points spaced substantially equally from center portion 39 or one side my be a different length than the other.

In the exemplary illustrated embodiment, the dual accessory mounting tubes 50 are rearwardly-opening accessory attachment receiver tubes and are square in cross section with each tube having a rearward-opening mouth 51, an upper wall 52, lower wall 53, and sidewalls 54 having hitch pin bores 55 therein and detent ring pins 56 for securing a variety of accessories. Dual accessory mounting tubes 50 are attached to the ends of cross bar tube 34 at their side walls 54, for example by welding. Accessory mounting tubes 50 are useful for attaching a basket as shown, or workbench, crate holder, bucket holder, tool box holder, salt and seed spreaders, or numerous other accessories.

The illustrated dual accessory mounting tubes 60 are upwardly-opening accessory attachment receiver tubes and are square in cross section with each tube having a upward-opening mouth 61, and four sidewalls 62 having hitch pin bores 63 therein and detent ring pins 56 for securing additional accessories. Dual accessory mounting tubes 60 are attached to the upper walls 52 of mounting tubes 50, as by welding. Accessory mounting tubes 60 provide additional tube support structure useful for attaching additional accessories such as a tree stand carrier, speed clamps, gun rack holder, and sun shade/weather canopy, or numerous additional accessories.

The illustrated dual accessory mounting tubes 70 are downwardly-opening accessory attachment receiver tubes and are square in cross section with each tube having a downward-opening mouth 71, and four sidewalls 72 having hitch pin bores 73 therein and detent ring pins 56 for securing additional accessories. Dual accessory mounting tubes 70 are attached to the lower walls 53 of mounting tubes 50, as by welding, and are useful for attaching additional accessories.

As best seen in FIG. 3, cross bar tube 34 can also contain rectangular bores 80 in side walls 37 at points spaced substantially equally from center portion 39 or at any other locations on the cross bar tube 34.

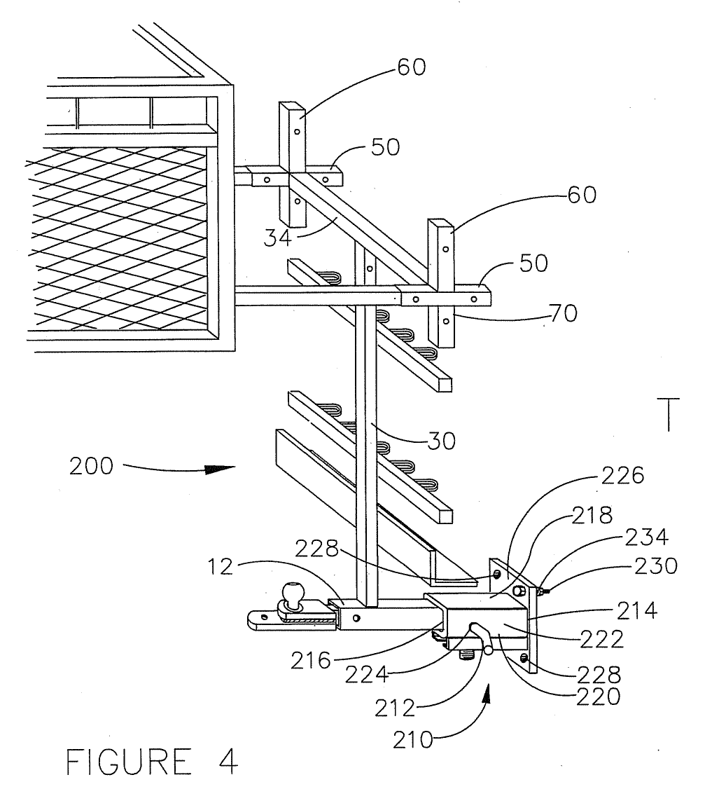

Referring to FIGS. 3, 4, 5 and 6 there is shown a rear perspective view, a side elevational view, a bottom plan view, and a rear elevational view of another embodiment of the present invention referred to by reference number 200. Accessory system assembly 200 includes the embodiments of the accessory system 10 as described above and incorporates a hitch receiver for bolting to a lawn and garden tractor. The hitch receiver can be removably mounted to the vehicle, for example by bolts.

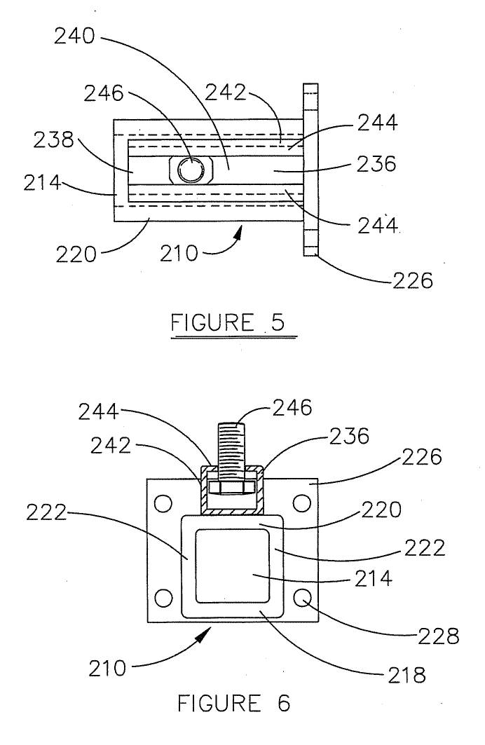

In the illustrated embodiment, accessory system shank 12 is inserted into receiver cavity of hitch receiver 210 and attached with hitch pin 212. Hitch receiver 210 includes a receiver tube 214 which is square in cross section and having a rearwardly-opening hollow receiver cavity 216, an upper wall 218, lower wall 220, and sidewalls 222 having hitch pin bore 224 therein. The forward end of receiver tube 214 is attached, as by welding, to a vehicle mounting plate, such as a tractor mounting plate 226. Tractor mounting plate 226 contains four bore holes 228 for attaching to tractor T with bolts 230, lock washers 232 and nuts 234. As best seen in FIG. 5, a drawbar bolt housing tube 236 is square in cross section having a rearward-opening hollow cavity 238, upper wall 240, side walls 242 and split open-channel lower wall 244. Upper wall 240 of drawbar bolt housing tube 236 is attached to lower wall 220 of receiver tube 214 and forward portion attached to tractor mounting plate 226, for example by welding. Drawbar attachment bolt 246 slides into drawbar bolt housing tube 236 and is free sliding within the tube from the forward section of the tube to the rearward section so as to permit aligning drawbar attachment bolt 246 with a drawbar hole in tractor when tractor mounting plate 226 is positioned against tractor rear shroud or drawbar. Drawbar attachment bolt 246 is inserted through drawbar hole in tractor and secured with flat washer 248, split lock washer 250 and nut 252. As best seen in FIG. 6, drawbar attachment bolt 246 is prevented from turning during tightening by two sides of the bolt head contacting the sidewalls 242 of drawbar bolt housing tube 236.

As will be appreciated by one skilled in the art, in lieu of bolting tractor mounting plate 226 to the tractor, lawn and garden tractor hitch 210 may be welded to the rear shroud or drawbar of the tractor in lieu of bolting to the tractor and become a feature of the tractor itself. Alternatively, receiver tube 214 may also be welded directly to the tractor negating the need for tractor mounting plate 226 and drawbar bolt housing tube 236.

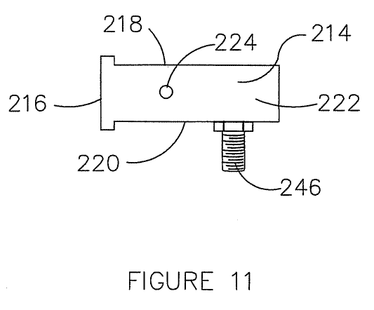

Alternatively, as best seen in FIG. 11, drawbar attachment bolt 246 may be attached directly to lower wall 220 of receiver tube 214, such as by welding, negating the need for drawbar bolt housing tube 236. With this embodiment, use of tractor mounting plate 226 is optional for tractor use and eliminated for use on an ATV. In addition to lawn and garden tractors and ATVs, this embodiment is particularly useful as a bumper-mounted hitch receiver in the automotive sector, as many trucks, sport utility vehicles, etc. come equipped with a bumper having a predrilled hole(s) for installing a conventional trailer hitch ball. This embodiment may include (not shown) additional ancillary structure if desired to prevent the receiver from turning or moving when side torque is applied.

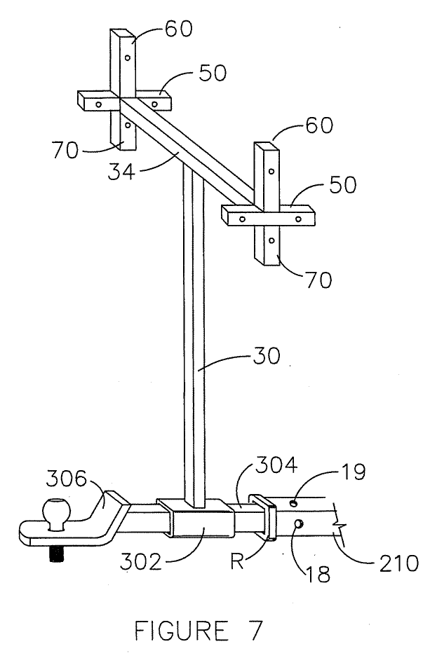

Referring to FIG. 7, there is shown a rear perspective view of another embodiment of the invention of FIG. 1 modified to attach to a lawn and garden tractor/ATV via a shank collar. In this embodiment, hitch attachment shank 12 of the previous embodiments is deleted from the accessory system, and shank collar 302 substituted in lieu thereof. Shank collar 302 slides over ball mount shank 304 and accessory system secured in place on ball mount shank 304 by ball mount platform 306 and face of receiver R. As can easily be recognized by one skilled in the art, shank collar 302 can be welded to ball mount shank resulting in the ball mount becoming a permanent feature of accessory system and serving as accessory attachment shank 12. Alternatively, upright support base member tube 30 can be directly welded to ball mount shank 304, eliminating the need for shank collar 302.

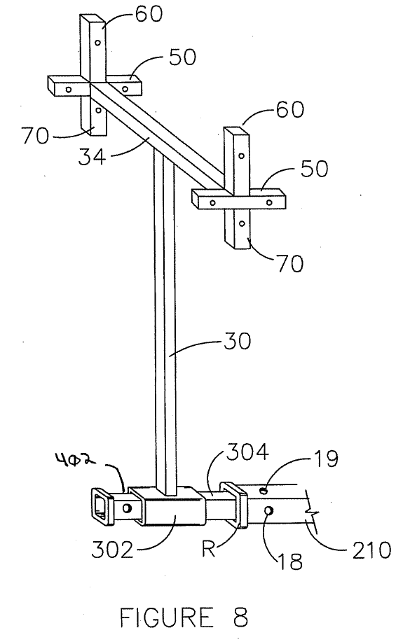

Referring to FIG. 8, there is shown a perspective view of another embodiment of FIG. 1, similar to that of FIG. 7. By modifying the size of shank collar 302, accessory system 30 is mounted on a receiver adapter, e.g., a receiver/ball mount extension/adapter/reducer 402. Alternatively, upright support base member tube 30 can be directly welded to receiver/ball mount extension/adapter/reducer 402, eliminating the need for shank collar 302.

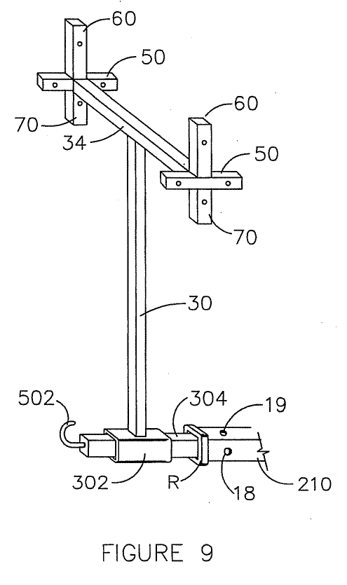

Referring to FIG. 9, there is shown a perspective view of another embodiment of FIG. 1, similar to that of FIG. 7. In this embodiment, accessory system 30 is mounted on the shank of a hitch accessory 502 other than a ball mount or ball mount extension when the use of a different accessory is desirable.

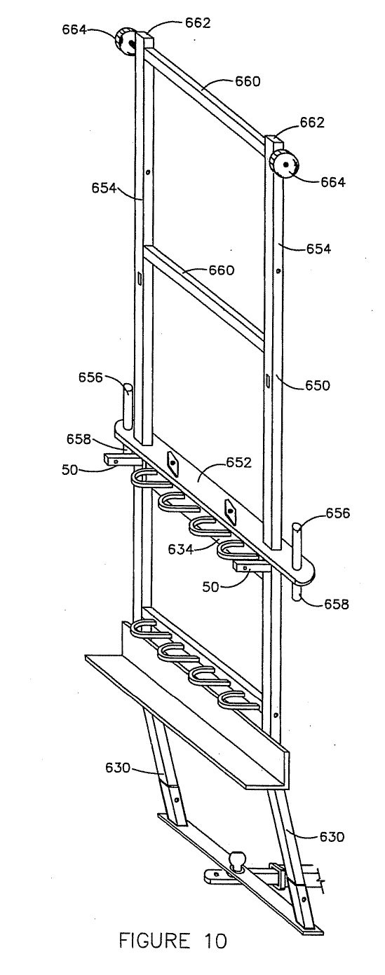

Referring to FIG. 10, there is shown a rear perspective view of yet another embodiment of the invention of FIG. 1 as mounted to an ATV or lawn and garden tractor with the Dual Receiver Tube Assembly embodying U.S. application Ser. No. 11/372,748 as described in Paragraph 0067 and shown in FIG. 3D as Reference Character 24 of that application. In this embodiment, single center upright tube support base member 30 is eliminated from the accessory system and dual upright base support tubes 630 substituted in lieu thereof. Dual base support tubes 630 are equal in distance from the center, e.g., attachment point, and are attached to an ATV or lawn and garden tractor by engaging the Dual Receiver Tube Assembly embodying U.S. application Ser. No. 11/372,748 as described in Paragraph 0067 and shown in FIG. 3D as Reference Character 24 of that application. In this embodiment, the cross member support tube 34 of the previous embodiments is substituted with cross member support 634 shown as angle iron, rather than square tubing, providing more contact surface for supporting additional support tube structure for mounting additional accessories.

Dual accessory mounting tubes 50 are mounted on cross member support 634 at the same distance as shown in the previous embodiments. Thus, accessories may be interchanged between support bases and from lawn and garden tractor to ATV and vice versa. Cross member support 634 also contains two bolts positioned upright to engage secondary accessory support frame 650. Secondary accessory support frame 650 has a flat bottom cross member 652 with two bores aligned with bolts on cross bar 634. Secondary accessory support frame 650 is attached to primary accessory support base cross bar 634 by sliding cross member 652 over bolts in cross bar 634 and securing with wing nut knobs or the like.

Secondary accessory support frame 650 has two upright support tubes 654 spaced evenly and equal to the distance between dual support tubes 60 of FIG. 1 to accommodate accessory interchangeability between ATV and lawn and garden tractor.

Upright support tubes 654 are hollow tubes and have open mouths 662 on their top end for sliding shanks or tubes within upright tubes 654 and securing with tightening knobs 664. Cross member tubes 660 are attached to and between upright support tubes 654. Accessory system bottom cross member 652 may also have dual support tubes 656 and 658, as shown, for attaching additional accessories. Secondary accessory support frame 650 is useful for attaching numerous additional accessories such as a tree stand carrier, speed grips, gun rack, weed eater carrier and sun shade/weather canopy.

The tube receivers and ball mount shanks of the present invention are preferably made of steel or other appropriate materials and may be square, round, or other shape to permit connecting accessories of matched shape. The length of all receiver tubes, support members, hitch bars, ball mounts, cross members, and shanks strips may be shortened or lengthened and the distance between all receiver tubes may be increased or decreased as desired. In addition, although most hitch receiver tubes illustrated in the drawings are typically 1.25 inches (3.2 cm) square, each embodiment may also be any desired dimension, such as 2 inches (5 cm) or other appropriate size. Gussets and other reinforcement elements (not shown) may be added as desired to the above-described embodiments of the invention.

In conjunction with the inventive lawn and garden tractor/ATV accessory system, the following list (intended to be illustrative and not exhaustive) of accessories can be attached to the accessory system: additional ball mounts, receiver extension/adapter/reducer, tow ring, shackle, tow hook, bicycle carrier, ski rack, canoe rack, ladder rack, luggage rack, truck extension, spare tire carrier, gas can carrier, steps, carry all, ATV carrier, grill carrier, cargo basket, ATV tie-down system, motorcycle carrier, wheel chair carrier, pet carrier, pet step, light bar, winch mount, generator stand, tree stand holder, bow holder, gun rack, fishing rod carrier, ice auger carrier, bucket carrier, crate carrier, tool carrier, tool box, cargo box, work bench, chain saw carrier, extension cord reel, garden hose reel, and seed and salt spreader.

In another embodiment, should a user not desire to attach the accessory system 10, 200 to the vehicle hitch receiver R, the structure below the cross member 34, 634 (for example, as shown in FIG. 3 or 10) can be eliminated. That is, the cross member 34, 634 can have one or more brackets or shanks to engage receiving tubes that can be attached to the vehicle, for example, by bolts, pinning or welding.

When it is impractical or undesirable to connect the accessory system 10, 200 to the equipment via the hitch, the accessory system (or components thereof) may be attached, such as by bolting, pinning, welding, or the like, to the ATV's frame, fenders, rack, bumper, bumper support bracket(s), rear axle, or other appropriate location or structure.

Similarly, when impractical or undesirable to connect to a tractor via the hitch, the accessory system (or components thereof) may be attached, such as by bolting, pinning, welding, or the like, to the tractor's frame, fenders, rear shroud, bumper, bumper support bracket(s), rear axle, tractor seat support base or frame, or other appropriate location.

It is to be understood that the present invention is not limited to the embodiments described above but encompasses any and all embodiments within the scope of the following claims.

What is claimed is:

1. A hitch-mounted vehicle accessory system, comprising:
an attachment shank configured to engage a vehicle hitch receiver;
at least one support base member connected to the attachment shank; and
at least one support element connected to the base member.

2. The system of claim 1, further comprising a plurality of accessory mounting tubes carried on the support element.

3. The assembly of claim 1, wherein the attachment shank includes a first end configured to engage a vehicle hitch receiver and a second end configured to receive a ball mount assembly or vehicle accessory assembly.

4. The system of claim 1 wherein the vehicle hitch receiver and attachment shank each include a vertical throughbore.

5. The system of claim 2, wherein the accessory mounting tubes include one or more of rearwardly opening tubes, upwardly opening tubes, or downwardly opening tubes.

6. The system of claim 1, wherein the support element comprises a cross bar tube.

7. The system of claim 6, wherein the cross bar tube comprises at least one rectangular receiver bore.

8. The system of claim 1, wherein the hitch receiver is removably mounted on the vehicle.

9. The system of claim 8, wherein the hitch receiver is attached to a mounting plate.

10. The system of claim 9, wherein the hitch receiver includes a drawbar bolt housing tube connected to the receiver tube.

11. The system of claim 10, wherein the drawbar bolt housing tube includes a split open channel and a drawbar attachment bolt slideable in the drawbar bolt housing tube and configured to engage a vehicle drawbar hole.

12. The system of claim 1, including a drawbar attachment bolt connected to the receiver tube.

13. A hitch-mounted vehicle accessory system comprising:
a shank collar configured to engage a shank of a hitch accessory;
a support base member connected to the shank collar; and
at least one support element connected to the support base member.

14. The system of claim 13, wherein the shank collar is removably connected to the shank of the hitch accessory.

15. The system of claim 13, wherein the hitch accessory is a receiver adaptor.

16. The system of claim 13, wherein the hitch accessory is a ball mount assembly.

17. The system of claim 1, further comprising a plurality of support base members.

18. The system of claim 17, comprising two spaced base support tubes.

19. The system of claim 18, comprising an accessory support frame connected to the support base member.
